(19) United States
(12) Patent Application Publication
(10) Pub. No.: US 2026/0032766 A1
(43) Pub. Date: Jan. 29, 2026

(54) CELL RESELECTION METHOD AND DEVICE

(71) Applicant: Samsung Electronics Co., Ltd., Suwon-si (KR)

(72) Inventors: Jin LIU, Suzhou (CN); Panhong DENG, Suzhou (CN)

(73) Assignee: Samsung Electronics Co., Ltd., Suwon-si (KR)

(21) Appl. No.: 18/906,567

(22) Filed: Oct. 4, 2024

(30) Foreign Application Priority Data
Jul. 23, 2024 (CN) 202410988421.3

(51) Int. Cl. H04W 76/28; H04W 36/30

(52) U.S. Cl. CPC H04W 76/28; H04W 36/30

(57) ABSTRACT

A cell reselection method including detecting whether a first network cell is configured with a first Connected Discontinuous Reception (CDRX) parameter, acquiring a first signal quality and at least one second signal quality in response to detecting that the first network cell is not configured with the first CDRX parameter or that the first CDRX parameter configured for the first network cell is not greater than a CDRX parameter threshold, the first signal quality corresponding to the first network cell, the at least one second signal quality respectively corresponding to at least one second network cell adjacent to the first network cell, determining whether to perform network cell reselection based on the first signal quality and the at least one second signal quality, and determining a reselected network cell from among the at least one second network cell in response to determining to perform the network cell reselection.

### CROSS-REFERENCE TO RELATED APPLICATION

This application is based on and claims priority under 35 U.S.C. § 119 to Chinese Patent Application No. 202410988421.3 filed on Jul. 23, 2024 in the Chinese Intellectual Property Office, the disclosure of which are incorporated by reference herein in their entirety.

### TECHNICAL FIELD

The present disclosure relates to the field of communication technology. More particularly, the present disclosure relates to a cell reselection method and device.

### BACKGROUND

In the process of network deployment, different operators in different regions will formulate different terminal camping network selection strategies according to local network coverage conditions. A corresponding network configuration parameter such as whether Connected Discontinuous Reception (CDRX) parameters are configured, or how long CDRX duration parameters are configured, is also different. According to instrumentation and cellular network test results, CDRX configuration states and parameters have a significant impact on the power consumption of the terminal in the Radio Resource Control (RRC) connection state.

At present, there is no active network selection action available for User Equipment (UE) when no CDRX is configured or when short period (40 ms) CDRX parameters are configured. Therefore, it is possible that the UE remains in the cell for a longer period of time, and when a packet is transmitted the UE is not able to enter into CDRX periodic sleeping, which in turn leads to the challenge of higher standby power consumption.

### SUMMARY

Example embodiments of the present disclosure are provide a cell reselection method and device, to provide technical solution for intelligently selecting a network with the best CDRX configuration on which to camp, thus the power consumption of the electronic device is saved. According to example embodiments, a terminal may actively check and store a CDRX configuration condition of a base station, so that in specific scenarios the terminal may intelligently and actively prioritize a cell configured with CDRX on which to camp, which may significantly improve the optimization of the terminal's power consumption and endurance (e.g., reduce the terminal's power consumption thereby increasing the terminal's endurance).

According to example embodiments of the present disclosure, there provides a cell reselection method, including: detecting whether a first network cell is configured with a first Connected Discontinuous Reception (CDRX) parameter, acquiring a first signal quality and at least one second signal quality in response to detecting that the first network cell is not configured with the first CDRX parameter or that the first CDRX parameter configured for the first network cell is not greater than a CDRX parameter threshold, the first signal quality corresponding to the first network cell, the at least one second signal quality respectively corresponding to at least one second network cell, and the at least one second network cell being adjacent to the first network cell, determining whether to perform network cell reselection based on the first signal quality and the at least one second signal quality, and determining a reselected network cell from among the at least one second network cell in response to determining to perform the network cell reselection.

Alternatively or additionally, the determining of the reselected network cell may include selecting a second network cell from among the at least one second network cell based on a cell reselection mechanism to obtain a selected second network cell, detecting whether the selected second network cell is configured with a second CDRX parameter, determining the selected second network cell as the reselected network cell in response to detecting that the selected network cell is configured with the second CDRX parameter, and selecting another second network cell from among the at least one second network cell based on the cell reselection mechanism in response to determining that the selected network cell is not configured with the second CDRX parameter.

Alternatively or additionally, the determining of the reselected network cell may include acquiring a respective second CDRX parameter for each of the at least one second network cell, and determining a second network cell having a largest respective second CDRX parameter among the at least one second network cell as the reselected network cell.

Alternatively or additionally, the cell reselection method may further include: determining not to perform the network cell reselection in response to detecting that the first CDRX parameter is greater than the CDRX parameter threshold.

Alternatively or additionally, the detecting of whether the first network cell is configured with the first CDRX parameter may include querying whether the first network cell is indicated in a database, determining that the first network cell is not configured with the first CDRX parameter based on the first network cell being indicated in the database, acquiring the first CDRX parameter of the first network cell in response to determining that the first network cell is not indicated in the database, and determining that the first network cell is configured with the first CDRX parameter in response to successful completion of the acquiring.

Alternatively or additionally, the cell reselection method may further include: unsuccessful, and recording the first network cell into the database in response to determining that the first network cell is not configured with the first CDRX parameter.

Alternatively or additionally, the cell reselection method may further include: determining one or more of the at least one second network cell is not configured with the second CDRX parameter in response to the acquiring being unsuccessful for the one or more of the at least one second network cell, and recording the one or more of the at least one second network cell into a database.

Alternatively or additionally, the first CDRX parameter may correspond to entry by an electronic device into a CDRX hibernation power saving state in a Radio Resource Control (RRC) connection state when the electronic device camps in the first network cell, and the second CDRX parameter may correspond to entry by the electronic device into the CDRX hibernation power saving state in the RRC connection state when the electronic device camps in the second network cell.

According to example embodiments of the present disclosure, there provides a cell reselection device, including: processing circuitry configured to detect whether a first network cell is configured with a first Connected Discontinuous Reception (CDRX) parameter, acquire a first signal quality and at least one second signal quality in response to detecting that the first network cell is not configured with the first CDRX parameter or that the first CDRX parameter configured for the first network cell is not greater than a CDRX parameter threshold, the first signal quality corresponding to the first network cell, the at least one second signal quality respectively corresponding to at least one second network cell, and the at least one second network cell being adjacent to the first network cell, determine whether to perform network cell reselection based on the first signal quality and the at least one second signal quality, and determine a reselected network cell from among the at least one second network cell in response to determining to perform the network cell reselection.

Alternatively or additionally, the processing circuitry may be configured to select a second network cell from among the at least one second network cell based on a cell reselection mechanism to obtain a selected second network cell, detect whether the selected second network cell is configured with a second CDRX parameter, determine the selected second network cell as the reselected network cell in response to detecting that the selected network cell is configured with the second CDRX parameter, and select another second network cell from among the at least one second network cell based on the cell reselection mechanism in response to determining that the selected network cell is not configured with the second CDRX parameter.

Alternatively or additionally, the processing circuitry may be configured to acquire a respective second CDRX parameter for each of the at least one second network cell, and determine a second network cell having a largest respective second CDRX parameter among the at least one second network cell as the reselected network cell.

Alternatively or additionally, the processing circuitry may be configured to determine not to perform the network cell reselection in response to detecting that the first CDRX parameter is greater than the CDRX parameter threshold.

Alternatively or additionally, the processing circuitry may be configured to query whether the first network cell is indicated in a database, determine that the first network cell is not configured with the first CDRX parameter based on the first network cell being indicated in the database, acquire the first CDRX parameter of the first network cell in response to determining that the first network cell is not indicated in the database, and determine that the first network cell is configured with the first CDRX parameter successfully acquiring the first CDRX parameter of the first network cell.

Alternatively or additionally, the processing circuitry may be configured to determine that the first network cell is not configured with the first CDRX parameter in response to a failure to acquire the first CDRX parameter of the first network cell, and record an indication of the first network cell into the database in response to determining that the first network cell is not configured with the first CDRX parameter.

Alternatively or additionally, the processing circuitry may be configured to determine that one or more of the at least one second network cell is not configured with the second CDRX parameter in response to a failure to acquire the respective second CDRX parameter for the one or more of the at least one second network cell, and record an indication of the one or more of the at least one second network cell into a database.

Alternatively or additionally, the first CDRX parameter may correspond to entry by an electronic device into a CDRX hibernation power saving state in a Radio Resource Control (RRC) connection state when the electronic device camps in the first network cell, and the second CDRX parameter may correspond to entry by the electronic device into the CDRX hibernation power saving state in the RRC connection state when the electronic device camps in the second network cell.

According to example embodiments of the present disclosure, there provides a non-transitory computer-readable storage medium storing a computer program that, when executed by at least one processor, causes the at least one processor to perform a cell reselection method, the cell reselection method including detecting whether a first network cell is configured with a first Connected Discontinuous Reception (CDRX) parameter, acquiring a first signal quality and at least one second signal quality in response to detecting that the first network cell is not configured with the first CDRX parameter or that the first CDRX parameter configured for the first network cell is not greater than a CDRX parameter threshold, the first signal quality corresponding to the first network cell, the at least one second signal quality respectively corresponding to at least one second network cell, and the at least one second network cell being adjacent to the first network cell, determining whether to perform network cell reselection based on the first signal quality and the at least one second signal quality, and determining a reselected network cell from among the at least one second network cell in response to determining to perform the network cell reselection.

According to example embodiments of the present disclosure, there provides a computing device including at least one processor, and at least a memory storing a computer program, wherein when the computer program is executed by the at least one processor, the cell reselection method according to example embodiments of the present disclosure is implemented.

According to example embodiments of the present disclosure, there provides a non-transitory computer program product, wherein computer programs in the non-transitory computer program product may be executed by a processor of the computer device to complete the cell reselection method according to example embodiments of the present disclosure.

The cell reselection method and device according to example embodiments of the present disclosure, by detecting whether a first network cell in which the electronic device currently camps is configured with a first Connected Discontinuous Reception (CDRX) parameter, acquiring a first signal quality of the first network cell and a second signal quality of each of at least one second network cell adjacent to the first network cell based on it being detected that the first network cell is not configured with the first CDRX parameter or it being detected that the first CDRX parameter configured for the first network cell is not greater than a predetermined (or alternatively, given) CDRX parameter threshold, determining whether to perform network cell reselection based on the first signal quality and the second signal quality, determining a reselected network cell from among the at least one second network cell when it is determined that the network cell reselection is to be performed, thereby saving the power consumption of the electronic device by intelligently selecting a network with the best CDRX configuration to camp.

Additional aspects and/or advantages of the general concept of the present disclosure will be partially explained in the following description, and still others will be clear from the description, or may be known through the implementation of the general concept of the present disclosure.

### BRIEF DESCRIPTION OF DRAWINGS

The above and other features of example embodiments of the present disclosure will become clearer through the following description in conjunction with the drawings that illustrate example embodiments, wherein:

FIG. 1 shows a flow chart of the cell reselection method according to example embodiments of the present disclosure;

FIG. 2 shows a diagram of the cell reselection according to example embodiments of the present disclosure;

FIG. 3 shows a block diagram of the cell reselection device according to example embodiments of the present disclosure;

FIG. 4 shows a diagram of the computing device according to example embodiments of the present disclosure; and

FIG. 5 shows a schematic diagram of a cell reselection system according to example embodiments of the present disclosure.

### DETAILED DESCRIPTION

Reference will now be made in detail to example embodiments of the present disclosure, examples of which are illustrated in the drawings, wherein the same reference numerals (or similar reference numerals) always refer to the same members (or similar members). Example embodiments are described below in order to explain the present disclosure by referring to the drawings.

The present disclosure provides a technical solution for an electronic device to intelligently select the network with an optimal CDRX configuration to camp, thereby saving power consumption of the electronic device. According to example embodiments, references to a network (or network cell) having a best or optimal CDRX configuration (or parameter) herein may refer to a network (or network cell) configured with the CDRX/or configured with a longer period CDRX.

When an electronic device (e.g., a user terminal UE) is in a static standby state, and the electronic device is frequently in a Radio Resource Control connection state due to the presence of data services in the backstage application (e.g., an application operating in the background of the electronic device), if the current service cell is not configured with a CDRX parameter (or is configured with a shorter period (40 ms) of CDRX), then the UE will not be able to enter into the CDRX hibernation power saving state under the Radio Resource Control connection state, and power consumption increases significantly. In such a state, in the present disclosure, it is designed to allow the electronic device to trigger the intelligent detection and network selection mechanism through the determination of a specific scenario, autonomously checking whether the cell in which it camps is configured with the CDRX parameter, and triggering the electronic device to carry out a cell reselection when it detects that the cell in which the UE camps is not configured with the CDRX (or is configured with the a shorter period (40 ms) of CDRX), and making the electronic device select a cell which is more optimal (configured with the CDRX/or configured with a longer period CDRX) cell to camp, so that the electronic device may save power consumption in the Radio Resource Control connected state when there are data services in the backstage application.

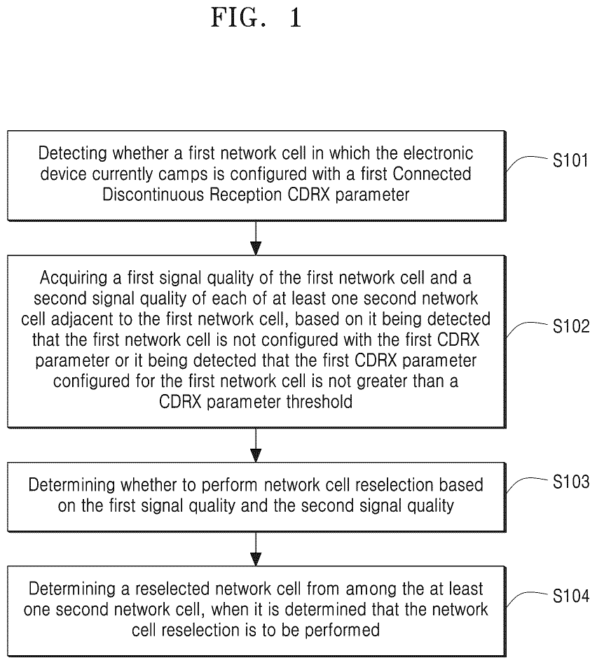

FIG. 1 shows a flow chart of the cell reselection method according to example embodiments of the present disclosure. The cell reselection method of the present disclosure may be applied where the electronic device is in a screen-off standby state and maintained for a period of time (which period of time may be set in advance). An application processor (AP) sends MIT_TRIGGER_PREF_CELL_IND via a Modem Interface for telephony (MIT) message to perform an optimal cell intelligent selection action. According to example embodiments, the operations discussed in connection with FIG. 1 may be performed by the electronic device. According to example embodiments, the electronic device may be fixed or mobile and may refer to any device that may communicate with a network cell, such as the first network cell, to transmit and receive data and/or control information. For example, the electronic device may be referred to as user equipment (UE), a terminal, a terminal equipment, a mobile station (MS), a mobile terminal (MT), a user terminal (UT), a subscriber station (SS), a wireless device, a handheld device, or the like.

A wireless communication network between the electronic device and network cells (e.g., the first network cell, the at least one second network cell, etc.) may support communication between multiple users by sharing available network resources. For example, in the wireless communication network, information may be transmitted in various multiple access schemes, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), OFDM-FDMA, OFDM-TDMA, and OFDM-CDMA.

According to example embodiments, the term “network cell” as used herein may generally refer to a fixed station that communicates with electronic devices and/or other network cells, and may exchange data and control information by communicating with electronic devices and/or other network cells. For example, the network cell may also be referred to as a Node B, an evolved-Node B (eNB), a next generation Node B (gNB), a sector, a site, a base transceiver system (BTS), an access point (AP), a relay node, a remote radio head (RRH), a radio unit (RU), a small cell, or the like. In the present specification, the network cell may be interpreted in a comprehensive sense to indicate some area or function covered by a base station controller (BSC) in CDMA, a Node-B in WCDMA, an eNB in long-term evolution (LTE), a gNB or sector (site) in 5G, and the like, and may cover all the various coverage areas such as megacell, macrocell, microcell, picocell, femtocell and relay node, RRH, RU, and small cell communication range.

Referring to FIG. 1, in operation S101, the electronic device may detect whether a first network cell in which the electronic device currently camps is configured with a first Connected Discontinuous Reception (CDRX) parameter. The PDCCH monitoring activity of the electronic device or the UE in RRC connected mode is governed by the DRX. When the DRX is configured, the electronic device or the UE does not have to continuously monitor the PDCCH. The DRX is characterized by the following:
(1) on-duration: a duration that the UE waits for, after wake up, to receive the PDCCH. If the UE successfully decodes a PDCCH, the UE stays awake and starts the inactivity timer;
(2) inactivity-timer: duration that the UE waits to successfully decode a PDCCH, from the last successful decoding of a PDCCH, and the UE can go back to sleep when failed. The UE shall restart the inactivity timer following a single successful decoding of a PDCCH for a first transmission only;
(3) retransmission-timer: a duration until a retransmission can be expected;
(4) cycle: it specifies the periodic repetition of the on-duration followed by a possible period of inactivity;
(5) active-time: the total duration that the UE monitors the PDCCH. This includes the “on-duration” of the DRX cycle, the duration in which the UE is performing continuous reception while the inactivity timer has not expired, and the duration in which the UE is performing continuous reception while waiting for a retransmission opportunity.

In example embodiments of the present disclosure, the first CDRX parameter is used for the electronic device to enter into (e.g., corresponds to entry by the electronic device into) a CDRX hibernation power saving state in a Radio Resource Control RRC connection state when the electronic device camps in the first network cell, thereby saving power consumption of the electronic devices residing in the first network cell.

In example embodiments of the present disclosure, the detecting of whether the first network cell in which the electronic device currently camps is configured with the first CDRX parameter may include: querying whether the first network cell exists in a predetermined (or alternatively, given) database; determining that the first network cell is not configured with the first CDRX parameter, when the first network cell exists in the predetermined (or alternatively, given) database; acquiring the first CDRX parameter of the first network cell, when the first network cell does not exist in the predetermined (or alternatively, given) database; determining that the first network cell is configured with the first CDRX parameter, based on the first CDRX parameter of the first network cell being acquired (e.g., in response to successful acquisition of the first CDRX parameter). Herein, the predetermined (or alternatively, given) database is used to record the network cells that have been camped by the electronic device, and their neighboring network cells, that are not configured with the CDRX parameter, thereby facilitating the determination of whether the network cells are configured with the CDRX parameter based on the predetermined (or alternatively, given) database. The neighboring network cells are a collection of cells with strongly piloted frequencies that a mobile station in the current network cell may search for. These pilot signals help the mobile station to switch during the mobile process to ensure communication continuity and quality. According to example embodiments, the predetermined (or alternatively, given) database includes (e.g., stores) indications corresponding to (e.g., identifiers of) network cells determined (e.g., by the electronic device) not to be configured with the CDRX parameter (e.g., the first CDRX parameter, the second CDRX parameter, etc.). According to example embodiments, discussion herein regarding determining whether a network cell exists in the predetermined (or alternatively, given) database may refer to determining whether the indication corresponding to the network cell is stored in the predetermined (or alternatively, given) database. According to example embodiments, the predetermined (or alternatively, given) database may be stored on the electronic device (e.g., in the memory 41), but example embodiments are not limited thereto. For example, the database may be stored on a remote server.

Specifically, a determination may be made (e.g., by the electronic device) as to whether the first network cell in which the electronic device currently camps is configured with a CDRX parameter, e.g., a first CDRX parameter, by checking a predetermined (or alternatively, given) database, which is a dynamically maintained list of all cells that are not configured with CDRX, and checking to confirm that the currently camping cell exists in the predetermined (or alternatively, given) database. If the current camping cell exists in the predetermined (or alternatively, given) database, it indicates that the current camping cell is not configured with the CDRX parameter. If the current camping cell does not exist in the predetermined (or alternatively, given) database, the current camping cell may be configured with the CDRX parameter.

In example embodiments of the present disclosure, the method may further include: determining that the first network cell is not configured with the first CDRX parameter based on the first CDRX parameter for the first network cell not being acquired (e.g., in response to a failure to acquire the first CDRX parameter), and recording the first network cell into the predetermined (or alternatively, given) database. Thus, the query accuracy is improved by updating the predetermined (or alternatively, given) database, and the query effectiveness of the predetermined (or alternatively, given) database is improved.

In operation S102, the electronic device may acquire a first signal quality of the first network cell and a second signal quality of each of at least one second network cell (e.g., at least one second signal quality respectively corresponding to the at least one second network cell) adjacent to the first network cell, based on it being detected (e.g., in response to detecting, for example, by the electronic device) that (1) the first network cell is not configured with the first CDRX parameter or (2) the first CDRX parameter configured for the first network cell is not greater than a predetermined (or alternatively, given) CDRX parameter threshold (e.g., a value of the first CDRX parameter is not greater than the predetermined (or alternatively, given) CDRX parameter threshold). Herein, the predetermined (or alternatively, given) CDRX parameter threshold may be, for example, but is not limited to, 40 ms. In addition, the predetermined (or alternatively, given) CDRX parameter threshold may be any value in the range of 30 ms-60 ms, and the present disclosure is not limited thereto. In addition, the predetermined (or alternatively, given) CDRX parameter threshold may be any value in the range of 20 ms-100 ms.

The electronic device or the UE needs to measure the RSRP (Reference Signal Receiving Power) and RSRQ (Reference Signal Received Quality) of the service network cell and adjacent areas, mainly in order to obtain the quality of the wireless link and reside in a cell with the best signal quality.

A network may configure the UE with an RRC_CONNECTED (RRC: Radio Resource Control) to perform measurements. The network may configure the UE to report them in accordance with the measurement configuration or perform conditional reconfiguration evaluation in accordance with the conditional reconfiguration.

In example embodiments of the present disclosure, the first signal quality may be, for example, but is not limited to, a reference signal received power (RSRP) and/or signal to interference plus noise ratio (SINR) value for the first network cell. The second signal quality may be, for example, but is not limited to, an RSRP and/or SINR value for the second network cell. In addition, the first signal quality and the second signal quality may be other parameters, and the present disclosure is not limited thereto.

In example embodiments of the present disclosure, the method may further include: determining not to perform the network cell reselection, based on it being detected (e.g., in response to detecting) that the first CDRX parameter configured for the first network cell is greater than the predetermined (or alternatively, given) CDRX parameter threshold. If the first CDRX parameter configured for the first network cell is detected to be greater than the predetermined (or alternatively, given) CDRX parameter threshold, it means that the electronic device is already in the optimal network cell and therefore network cell reselection may not be performed.

In operation S103, the electronic device may determine whether to perform network cell reselection based on the first signal quality and the second signal quality (e.g., the at least one second signal quality). For example, the RSRP/SINR values of the current camping cell and the neighboring cells are checked to confirm the signal quality of the current camping cell and the neighboring cells in order to confirm whether the neighboring cells meet an idle state reselection difference condition, so as to avoid (or reduce) the occurrence of ping-pong reselection.

In example embodiments of the present disclosure, the determining of whether to perform the network cell reselection based on the first signal quality and the second signal quality may include: determining, based on the first signal quality and the second signal quality, whether the at least one second network cell meets the idle state reselection difference condition; determining to perform the network cell reselection based on the at least one second network cell meeting the idle state reselection difference condition; determining not to perform the network cell reselection based on the at least one second network cell not meeting the idle state reselection difference condition, thereby avoiding (or reducing) the occurrence of ping-pong reselection. The idle state reselection difference condition means that in the idle state, when residing on a network cell, the UE shall periodically search for a better network cell based on the cell reselection criteria (R criteria), and determine the conditions that need to be satisfied by the better network cell that is searched for when performing network cell reselection. If the difference between the first signal quality and the second signal quality is greater than a specified threshold, the idle state reselection difference condition is satisfied; if the difference between the first signal quality and the second signal quality is not greater than a specified threshold, the idle state reselection difference condition is not satisfied.

In operation S104, the electronic device may determine a reselected network cell from among the at least one second network cell, when it is determined (e.g., by the electronic device) that the network cell reselection is to be performed (e.g., in response to determining to perform the network cell reselection). According to example embodiments, the electronic device may perform a handover to the reselected network cell, establish an RRC connection with the reselected network cell, and/or enter a CDRX hibernation power saving state on the reselected network cell (e.g., after the completion of the handover and the establishment of the RRC connection).

In example embodiments of the present disclosure, the determining of the reselected network cell from among the at least one second network cell may include: selecting a second network cell from among the at least one second network cell by (e.g., based on or using) a cell reselection mechanism; detecting whether the selected second network cell is configured with a second CDRX parameter; determining the selected second network cell as the reselected network cell based on it being detected (e.g., in response to detecting) that the selected network cell is configured with the second CDRX parameter; performing the network cell reselection again, based on it being detected (e.g., selecting another second network cell from among the at least one second network cell based on the cell reselection mechanism in response to determining) that the selected network cell is not configured with the second CDRX parameter. If the selected second network cell is still not configured with the CDRX parameter, the operation of the network cell reselection is repeated until the reselected network cell is determined.

As an example, according to the cell reselection mechanism, the UE shall perform measurements used for the purpose of network cell selection and reselection purposes, and while residing on a network cell, the UE shall periodically search for a better network cell based on the cell reselection criteria (R-criteria). If a better network cell is found, the network cell is selected. The UE shall periodically search for better network cells based on the network cell reselection criteria. The R-criteria means that the UE shall calculate the signal quality (e.g., R-value) of all surrounding network cells and rank them according to the size of the signal quality (e.g., R-value), and the network cell in the first place will be considered as the optimal network cell.

In example embodiments of the present disclosure, the determining of the reselected network cell from among the at least one second network cell may include: acquiring a second CDRX parameter (e.g., a second respective CDRX parameter) for each of the at least one second network cell; determining the reselected network cell from among the at least one second network cell based on the second CDRX parameter. Thus, the network cell with optimal CDRX parameter is selected.

In example embodiments of the present disclosure, the determining of the reselected network cell from among the at least one second network cell based on the second CDRX parameter may include: determining a second network cell having a largest second CDRX parameter (e.g., a largest respective second CDRX parameter) among the at least one second network cell as the reselected network cell. That is, it attempts to find a network cell configured with a long period CDRX parameter on which to camp.

In example embodiments of the present disclosure, the determining of the reselected network cell from among the at least one second network cell may include: acquiring a second CDRX parameter for each of the at least one second network cell; determining the second network cell having the largest second CDRX parameter among the at least one second network cell as the reselected network cell. Thus, the network cell configured with longer-period CDRX parameter is selected for camping, so that power consumption of the electronic device is saved.

In addition, in determining the reselected network cell from among the at least one second network cell based on the second CDRX parameter, the reselected network cell may also be selected from among the at least one second network cell by other methods, which are not limited by the present disclosure. For example, a second network cell whose other parameters meet a predetermined (or alternatively, given) condition may be selected as the reselected network cell from among the plurality of second network cells whose second CDRX parameters meet the condition.

In example embodiments of the present disclosure, the method may further include: determining that the second network cell (e.g., one or more second network cell among the at least one second network cell) is not configured with the second CDRX parameter based on the second CDRX parameter for the second network cell not being acquired (e.g., in response to a failure to acquire the second CDRX parameter for one or more of the at least one second network cell), and recording the second network cell (e.g., the one or more of the at least one second network cell) into the predetermined (or alternatively, given) database. Herein, the predetermined (or alternatively, given) database is used to record the network cells that have been camped by the electronic device and their neighboring network cells that are not configured with the CDRX parameter, thereby facilitating the determination of whether the network cells are configured with the CDRX parameter based on the predetermined (or alternatively, given) database. In this way, the predetermined (or alternatively, given) database is continuously improved with the increasing number of network cells that have been camped by the electronic device. In addition, the predetermined (or alternatively, given) CDRX parameter thresholds may be included in the predetermined (or alternatively, given) database.

In example embodiments of the present disclosure, the second CDRX parameter is used for the electronic device to enter into (e.g., corresponds to entry by the electronic device into) the CDRX hibernation power saving state in the RRC connection state when the electronic device camps in the second network cell, thereby saving power consumption of the electronic devices residing in the second network cell. According to example embodiments, the first CDRX parameter may be the same as, similar to, or different from the second CDRX parameter.

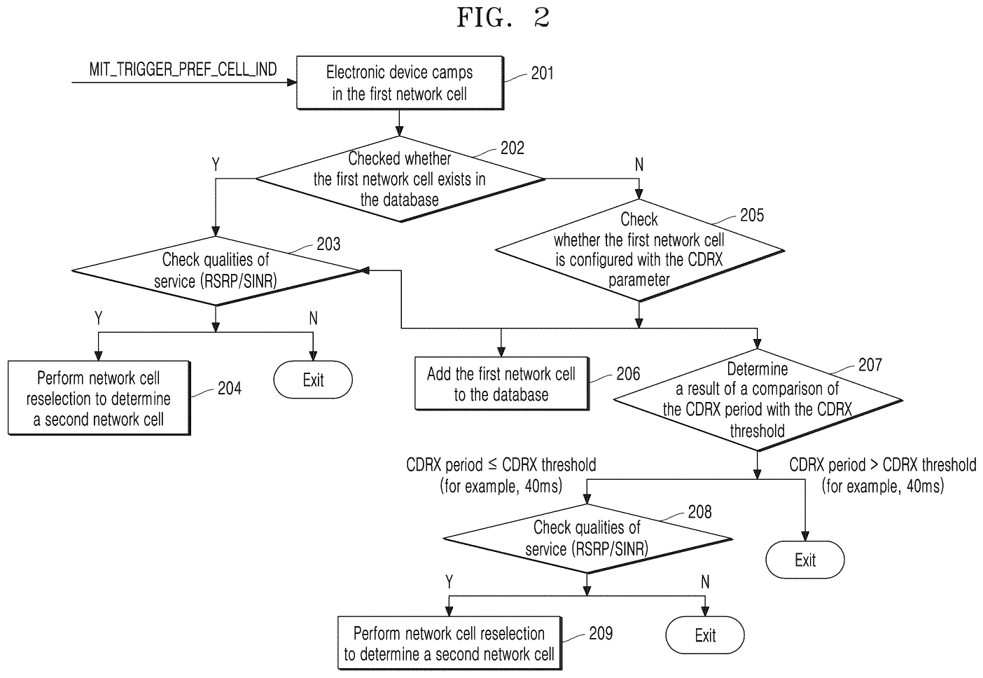

FIG. 2 shows a diagram of the cell reselection according to example embodiments of the present disclosure. According to example embodiments, the operations discussed in connection with FIG. 2 may be performed by the electronic device discussed in connection with FIG. 1. As shown in FIG. 2, upon receiving the message MIT_TRIGGER_PREF_CELL_IND, at operation 201, the electronic device camps in the first network cell. At operation 202, it is checked whether the first network cell exists in the database. When the first network cell exists in the database, at operation 203, the qualities of service (RSRP/SINR) of the first network cell and its neighbors are checked and, if the qualities of service meet the condition, at operation 204, network cell reselection is performed to determine a second network cell. According to example embodiments, if the electronic device determines that the qualities of service do not meet the condition in operation 203, the cell reselection process ends. When the first network cell does not exist in the database, at operation 205, it is checked whether the first network cell is configured with the CDRX parameter. If the first network cell is not configured with the CDRX parameter, at operation 206, the first network cell is added to the database and a jump is made to operation 203. If the first network cell is configured with the CDRX parameter, at operation 207, a result of a comparison of the CDRX period with the CDRX threshold is determined. If the CDRX period≤CDRX threshold (40 ms), at operation 208, the qualities of service (RSRP/SINR) of the first network cell and its neighboring network cells are checked and, if the qualities of services meet the condition, at operation 209, the network cell reselection is performed to determine the second network cell. Then the electronic device starts checking the CDRX parameter of the second network cell, and if the CDRX parameter of the second network cell satisfies the preference conditions, the electronic device resides in the second network cell, and if the CDRX parameter of the second network cell does not satisfy the preference conditions, the electronic device does not reside in the second network cell. According to example embodiments, if the electronic device determines that the CDRX period is greater than the CDRX threshold (40 ms) in operation 207 or if the electronic device determines that the qualities of services do not meet the condition in operation 208, the cell reselection process ends, the electronic device does not trigger the cell reselection to avoid ping-pong reselection.

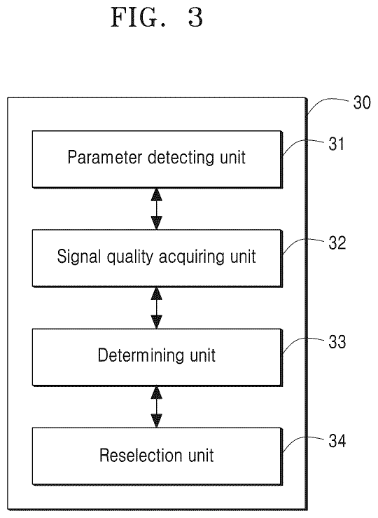

The cell reselection method according to example embodiments of the present disclosure has been described above in conjunction with FIG. 1 and FIG. 2. Hereinafter, the cell reselection device according to example embodiments of the present disclosure will be described with reference to FIG. 3.

FIG. 3 shows a block diagram of the cell reselection device according to example embodiments of the present disclosure.

Referring to FIG. 3, the cell reselection device 30 includes a parameter detecting unit 31, a signal quality acquiring unit 32, a determining unit 33, and/or a reselection unit 34. According to example embodiments, the cell reselection device 30 may be, or may be included in, the electronic device discussed in connection with FIGS. 1-2.

The parameter detecting unit 31 is configured to detect whether a first network cell in which the electronic device currently camps is configured with a first Connected Discontinuous Reception (CDRX) parameter.

In example embodiments of the present disclosure, the parameter detecting unit 31 may be configured to: query whether the first network cell exists in a predetermined (or alternatively, given) database, to determine that the first network cell is not configured with the first CDRX parameter; acquire the first CDRX parameter of the first network cell when the first network cell exists in the predetermined (or alternatively, given) database; and determine that the first network cell is configured with the first CDRX parameter based on the first CDRX parameter of the first network cell being acquired, when the first network cell does not exist in the predetermined (or alternatively, given) database.

In example embodiments of the present disclosure, the cell reselection device 30 may further include a first recording unit (not shown) configured to determine that the first network cell is not configured with the first CDRX parameter based on the first CDRX parameter for the first network cell not being acquired, and to record the first network cell into the predetermined (or alternatively, given) database.

The signal quality acquiring unit 32 is configured to acquire a first signal quality of the first network cell and a second signal quality of each of at least one second network cell adjacent to the first network cell based on it being detected that the first network cell is not configured with the first CDRX parameter or it being detected that the first CDRX parameter configured for the first network cell is not greater than a predetermined (or alternatively, given) CDRX parameter threshold.

In example embodiments of the present disclosure, the cell reselection device 30 may further include an exiting unit (not shown) configured to determine not to perform the network cell reselection, based on it being detected that the first CDRX parameter configured for the first network cell is greater than the predetermined (or alternatively, given) CDRX parameter threshold.

The determining unit 33 is configured to determine whether to perform network cell reselection based on the first signal quality and the second signal quality;

In example embodiments of the present disclosure, the determining unit 33 may be configured to: determine, based on the first signal quality and the second signal quality, whether the at least one second network cell meets the idle state reselection difference condition; determine to perform the network cell reselection based on the at least one second network cell meeting the idle state reselection difference condition; and determine not to perform the network cell reselection based on the at least one second network cell not meeting the idle state reselection difference condition.

The reselection unit 34 is configured to determine a reselected network cell from among the at least one second network cell, when it is determined that the network cell reselection is to be performed.

In example embodiments of the present disclosure, the reselection unit 34 may be configured to select a second network cell from among the at least one second network cell by a cell reselection mechanism, detect whether the selected second network cell is configured with a second CDRX parameter, determine the selected second network cell as the reselected network cell based on it being detected that the selected network cell is configured with the second CDRX parameter, and perform the network cell reselection again based on it being detected that the selected network cell is not configured with the second CDRX parameter.

In example embodiments of the present disclosure, the reselection unit 34 may be configured to acquire a second CDRX parameter for each of the at least one second network cell, and determine the reselected network cell from among the at least one second network cell based on the second CDRX parameter.

In example embodiments of the present disclosure, the reselection unit 34 may be configured to determine a second network cell having a largest second CDRX parameter from among the at least one second network cell as the reselected network cell.

In example embodiments of the present disclosure, the reselection unit 34 may be configured to acquire a second CDRX parameter for each of the at least one second network cell, and determine a second network cell having a largest second CDRX parameter from among the at least one second network cell as the reselected network cell.

In example embodiments of the present disclosure, the cell reselection device 30 may further include a second recording unit (not shown) configured to determine that the second network cell is not configured with the second CDRX parameter based on the second CDRX parameter for the second network cell not being acquired, and record the second network cell into the predetermined (or alternatively, given) database.

In example embodiments of the present disclosure, the first CDRX parameter may be used for the electronic device to enter into a CDRX hibernation power saving state in a Radio Resource Control RRC connection state when the electronic device camps in the first network cell, and the second CDRX parameter may be used for the electronic device to enter into the CDRX hibernation power saving state in the RRC connection state when the electronic device camps in the second network cell.

In addition, according to example embodiments of the present disclosure, there also provides a non-transitory computer-readable storage medium having a computer program stored thereon, and when the computer program is executed, the cell reselection method according to example embodiments of the present disclosure is implemented.

In example embodiments of the present disclosure, the non-transitory computer-readable storage medium may carry one or more programs that, when executed, may implement the following operations: detecting whether a first network cell in which the electronic device currently camps is configured with a first Connected Discontinuous Reception CDRX parameter; acquiring a first signal quality of the first network cell and a second signal quality of each of at least one second network cell adjacent to the first network cell, based on it being detected that the first network cell is not configured with the first CDRX parameter or it being detected that the first CDRX parameter configured for the first network cell is not greater than a predetermined (or alternatively, given) CDRX parameter threshold; determining whether to perform network cell reselection based on the first signal quality and the second signal quality; and determining a reselected network cell from among the at least one second network cell, when it is determined that the network cell reselection is to be performed.

The non-transitory computer-readable storage medium may be, for example, but is not limited to, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash memory), optical fiber, portable compact disk read only memory (CD-ROM), optical storage devices, magnetic storage devices, or any suitable combination of the above. In example embodiments of the present disclosure, a non-transitory computer-readable storage medium may be any tangible medium that contains or stores a computer program that may be used by or in conjunction with an instruction execution system, apparatus, or device. The computer program contained on the non-transitory computer-readable storage medium may be transmitted using any appropriate medium, including but not limited to: wire, fiber optic cable, RF (radio frequency), etc., or any suitable combination of the above. The non-transitory computer-readable storage medium may be included in any device; it may also exist alone without being incorporated into the device.

In addition, according to example embodiments of the present disclosure, there also provides a non-transitory computer program product, wherein instructions in the non-transitory computer program product may be executed by a processor of the computer device to complete the cell reselection method according to example embodiments of the present disclosure.

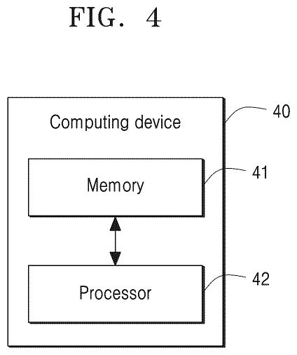

The cell reselection device 30 according to example embodiments of the present disclosure has been described above in conjunction with FIG. 3. Next, a computing device according to example embodiments of the present disclosure will be described in conjunction with to FIG. 4.

FIG. 4 shows a diagram of the computing device according to example embodiments of the present disclosure.

Referring to FIG. 4, a computing device 40 according to example embodiments of the present disclosure includes a memory 41 and/or a processor 42, and the memory 41 stores a computer program. When the computer program is executed by the processor 42, the cell reselection method according to example embodiments of the present disclosure is implemented. According to example embodiments, the computing device 40 may be, or may be included in, the electronic device discussed in connection with FIGS. 1-2. According to example embodiments, the computing device 40 may be used to implement the cell reselection device 30.

In example embodiments of the present disclosure, when the computer program is executed by the processor 42, the following operations may be implemented: detecting whether a first network cell in which the electronic device currently camps is configured with a first Connected Discontinuous Reception CDRX parameter; acquiring a first signal quality of the first network cell and a second signal quality of each of at least one second network cell adjacent to the first network cell, based on it being detected that the first network cell is not configured with the first CDRX parameter or it being detected that the first CDRX parameter configured for the first network cell is not greater than a predetermined (or alternatively, given) CDRX parameter threshold; determining whether to perform network cell reselection based on the first signal quality and the second signal quality; and determining a reselected network cell from among the at least one second network cell, when it is determined that the network cell reselection is to be performed.

The computing device in example embodiments of the present disclosure may include, but is not limited to, devices such as those containing a processor CPU computing function. The computing device shown in FIG. 4 is only an example, and should not impose any limitation on the function and scope of use of example embodiments of the present disclosure.

The cell reselection method and device according to example embodiments of the present disclosure have been described above with reference to FIGS. 1-4. However, it should be understood: the cell reselection device shown in FIG. 3 may be respectively configured as software, hardware, firmware or any combination of the above to perform specific functions, and the computing device shown in FIG. 4 is not limited to including the above shown components, but some components may be added or deleted, and the above components may also be combined.

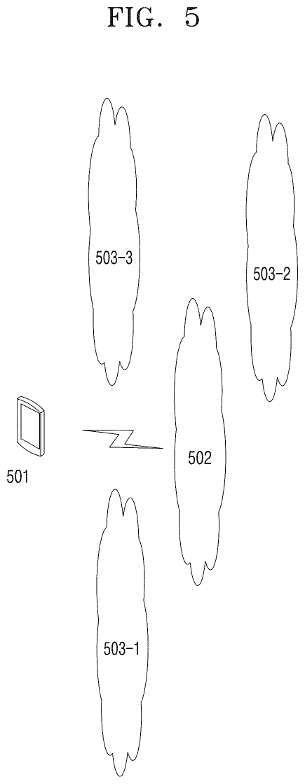

FIG. 5 shows a schematic diagram of a cell reselection system according to example embodiments of the present disclosure.

As shown in FIG. 5, the cell reselection system includes an electronic device 501, a first network cell 502, a second network cell 503-1, a second network cell 503-2, and a second network cell 503-3. The electronic device 501 is currently residing in the first network cell 502, and the electronic device 501 checks whether the first network cell exists in a database at a particular time.

If the first network cell 502 exists in the database, the quality of service (RSRP/SINR) of the first network cell 502 and its neighboring second network cell 503-1, second network cell 503-2, second network cell 503-3 are checked. If the electronic device 501 determines that the qualities of service meet the condition, it performs the network cell reselection to determine the reselected second network cell from among the second network cell 503-1, the second network cell 503-2, and the second network cell 503-3. If the electronic device 501 determines that the qualities of service do not meet the condition, the cell reselection process ends.

If the first network cell 502 does not exist in the database, the electronic device 501 checks whether the first network cell 502 is configured with a CDRX parameter. If the first network cell 502 is not configured with the CDRX parameter, the electronic device 501 adds the first network cell 502 into the database. If the first network cell 502 is configured with the CDRX parameter, the electronic device 501 determines a result of comparison of the CDRX period with the CDRX threshold. If the CDRX period≤the CDRX threshold (40 ms), the electronic device 501 checks the qualities of service (RSRP/SINR) of the first network cell 502 and its neighboring second network cell 503-1, second network cell 503-2, and second network cell 503-3. If the electronic device 501 determines that the qualities of service meet the condition, it performs the network cell reselection to determine a reselected second network cell from among the second network cell 503-1, the second network cell 503-2, and the second network cell 503-3.

For example, if the reselected second network cell is the second network cell 503-1, a CDRX parameter of the second network cell 503-1 is checked, and if the CDRX parameter of the second network cell 503-1 meets the preference condition, the electronic device resides in the second network cell 503-1.

For example, if the reselected second network cell is the second network cell 503-2, the CDRX parameter of the second network cell 503-2 is checked, and if the CDRX parameter of the second network cell 503-2 meets the preference conditions, the electronic device resides in the second network cell 503-2.

For example, if the reselected second network cell is second network cell 503-3, the CDRX parameter of second network cell 503-3 is checked, and if the CDRX parameter of second network cell 503-3 meets the preference condition, the electronic device resides in second network cell 503-3.

The cell reselection method and device according to example embodiments of the present disclosure, by detecting whether a first network cell in which the electronic device currently camps is configured with a first Connected Discontinuous Reception CDRX parameter, acquiring a first signal quality of the first network cell and a second signal quality of each of at least one second network cell adjacent to the first network cell based on it being detected that the first network cell is not configured with the first CDRX parameter or it being detected that the first CDRX parameter configured for the first network cell is not greater than a predetermined (or alternatively, given) CDRX parameter threshold, determining whether to perform network cell reselection based on the first signal quality and the second signal quality, determining a reselected network cell from among the at least one second network cell when it is determined that the network cell reselection is to be performed, thereby saving the power consumption of the electronic device by intelligently selecting a network with the best CDRX configuration to camp.

Conventional devices and methods for performing wireless communication do not consider CDRX capabilities of network cells in determining a network cell on which an electronic device will camp. Accordingly, the conventional devices and methods involve an excessive amount of camping on network cells having insufficient CDRX capabilities. During such camping, electronic devices are unable to sufficiently utilize the power saving enabled by the CDRX hibernation power saving state. Therefore, the conventional devices and methods result in excessive power consumption in the electronic devices.

However, according to example embodiments, improved devices and methods for network cell selection are provided. For example, the improved devices and methods may perform a network cell reselection in response to detecting that a network cell on which an electronic device is camped is not configured with a CDRX parameter or configured with a value of the CDRX parameter not greater than a CDR parameter threshold. Accordingly, the improved devices and methods may avoid or reduce the amount of camping by the electronic device on network cells having insufficient CDRX capabilities. Therefore, the improved devices and methods overcome the deficiencies of the conventional devices and methods to at least reduce power consumption in the electronic devices through improved access to the CDRX hibernation power saving state.

According to example embodiments, operations described herein as being performed by the cell reselection device 30, the parameter detecting unit 31, the signal quality acquiring unit 32, the determining unit 33, the reselection unit 34, the first recording unit, the exiting unit, the second recording unit, the computing device 40, and/or the processor 42 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 41). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Although the present disclosure has been specifically shown and described with reference to example embodiments thereof, those skilled in the art should understand that various changes of the forms and details may be made without departing from the spirit and scope of the present disclosure as defined by the claims.

1. A cell reselection method, comprising:
detecting whether a first network cell is configured with a first Connected Discontinuous Reception (CDRX) parameter;
acquiring a first signal quality and at least one second signal quality in response to detecting that the first network cell is not configured with the first CDRX parameter or that the first CDRX parameter configured for the first network cell is not greater than a CDRX parameter threshold, the first signal quality corresponding to the first network cell, the at least one second signal quality respectively corresponding to at least one second network cell, and the at least one second network cell being adjacent to the first network cell;
determining whether to perform network cell reselection based on the first signal quality and the at least one second signal quality; and
determining a reselected network cell from among the at least one second network cell in response to determining to perform the network cell reselection.

2. The cell reselection method according to claim 1, wherein the determining of the reselected network cell comprises:
selecting a second network cell from among the at least one second network cell based on a cell reselection mechanism to obtain a selected second network cell;
detecting whether the selected second network cell is configured with a second CDRX parameter;
determining the selected second network cell as the reselected network cell in response to detecting that the selected network cell is configured with the second CDRX parameter; and
selecting another second network cell from among the at least one second network cell based on the cell reselection mechanism in response to determining that the selected network cell is not configured with the second CDRX parameter.

3. The cell reselection method according to claim 1, wherein the determining of the reselected network cell comprises:
acquiring a respective second CDRX parameter for each of the at least one second network cell; and
determining a second network cell having a largest respective second CDRX parameter among the at least one second network cell as the reselected network cell.

4. The cell reselection method according to claim 1, further comprising:
determining not to perform the network cell reselection in response to detecting that the first CDRX parameter is greater than the CDRX parameter threshold.

5. The cell reselection method according to claim 1, wherein the detecting of whether the first network cell is configured with the first CDRX parameter comprises:
querying whether the first network cell is indicated in a database;
determining that the first network cell is not configured with the first CDRX parameter based on the first network cell being indicated in the database;
acquiring the first CDRX parameter of the first network cell in response to determining that the first network cell is not indicated in the database; and
determining that the first network cell is configured with the first CDRX parameter in response to successful completion of the acquiring.

6. The cell reselection method according to claim 5, further comprising:
determining that the first network cell is not configured with the first CDRX parameter in response to the acquiring being unsuccessful; and
recording the first network cell into the database in response to determining that the first network cell is not configured with the first CDRX parameter.

7. The cell reselection method according to claim 3, further comprising:
determining one or more of the at least one second network cell is not configured with the second CDRX parameter in response to the acquiring being unsuccessful for the one or more of the at least one second network cell; and
recording the one or more of the at least one second network cell into a database.

8. The cell reselection method according to claim 2, wherein
the first CDRX parameter corresponds to entry by an electronic device into a CDRX hibernation power saving state in a Radio Resource Control (RRC) connection state when the electronic device camps in the first network cell; and
the second CDRX parameter corresponds to entry by the electronic device into the CDRX hibernation power saving state in the RRC connection state when the electronic device camps in the second network cell.

9. A cell reselection device, comprising:
processing circuitry configured to
detect whether a first network cell is configured with a first Connected Discontinuous Reception (CDRX) parameter,
acquire a first signal quality and at least one second signal quality in response to detecting that the first network cell is not configured with the first CDRX parameter or that the first CDRX parameter configured for the first network cell is not greater than a CDRX parameter threshold, the first signal quality corresponding to the first network cell, the at least one second signal quality respectively corresponding to at least one second network cell, and the at least one second network cell being adjacent to the first network cell,
determine whether to perform network cell reselection based on the first signal quality and the at least one second signal quality, and
determine a reselected network cell from among the at least one second network cell in response to determining to perform the network cell reselection.

10. The cell reselection device according to claim 9, wherein the processing circuitry is configured to:
select a second network cell from among the at least one second network cell based on a cell reselection mechanism to obtain a selected second network cell;
detect whether the selected second network cell is configured with a second CDRX parameter;
determine the selected second network cell as the reselected network cell in response to detecting that the selected network cell is configured with the second CDRX parameter; and
select another second network cell from among the at least one second network cell based on the cell reselection mechanism in response to determining that the selected network cell is not configured with the second CDRX parameter.

11. The cell reselection device according to claim 9, wherein the processing circuitry is configured to:
acquire a respective second CDRX parameter for each of the at least one second network cell; and
determine a second network cell having a largest respective second CDRX parameter among the at least one second network cell as the reselected network cell.

12. The cell reselection device according to claim 9, wherein the processing circuitry is configured to:
determine not to perform the network cell reselection in response to detecting that the first CDRX parameter is greater than the CDRX parameter threshold.

13. The cell reselection device according to claim 9, wherein the processing circuitry is configured to:
query whether the first network cell is indicated in a database;
determine that the first network cell is not configured with the first CDRX parameter based on the first network cell being indicated in the database;
acquire the first CDRX parameter of the first network cell in response to determining that the first network cell is not indicated in the database; and
determine that the first network cell is configured with the first CDRX parameter successfully acquiring the first CDRX parameter of the first network cell.

14. The cell reselection device according to claim 13, wherein the processing circuitry is configured to:
determine that the first network cell is not configured with the first CDRX parameter in response to a failure to acquire the first CDRX parameter of the first network cell; and
record an indication of the first network cell into the database in response to determining that the first network cell is not configured with the first CDRX parameter.

15. The cell reselection device according to claim 11, wherein the processing circuitry is configured to:
determine that one or more of the at least one second network cell is not configured with the second CDRX parameter in response to a failure to acquire the respective second CDRX parameter for the one or more of the at least one second network cell, and
record an indication of the one or more of the at least one second network cell into a database.

16. The cell reselection device according to claim 10, wherein
the first CDRX parameter corresponds to entry by an electronic device into a CDRX hibernation power saving state in a Radio Resource Control (RRC) connection state when the electronic device camps in the first network cell; and
the second CDRX parameter corresponds to entry by the electronic device into the CDRX hibernation power saving state in the RRC connection state when the electronic device camps in the second network cell.

17. A non-transitory computer-readable storage medium storing a computer program that, when executed by at least one processor, causes the at least one processor to perform a cell reselection method, the cell reselection method comprising:
detecting whether a first network cell is configured with a first Connected Discontinuous Reception (CDRX) parameter;
acquiring a first signal quality and at least one second signal quality in response to detecting that the first network cell is not configured with the first CDRX parameter or that the first CDRX parameter configured for the first network cell is not greater than a CDRX parameter threshold, the first signal quality corresponding to the first network cell, the at least one second signal quality respectively corresponding to at least one second network cell, and the at least one second network cell being adjacent to the first network cell;
determining whether to perform network cell reselection based on the first signal quality and the at least one second signal quality; and
determining a reselected network cell from among the at least one second network cell in response to determining to perform the network cell reselection.

18. (canceled)

19. The cell reselection method according to claim 1, further comprising:
performing a handover to the reselected network cell.

20. The cell reselection method according to claim 19, further comprising:
entering a CDRX hibernation power saving state after the performing the handover.
